(19) United States
(12) Patent Application Publication
(10) Pub. No.: US 2026/0290042 A1
(43) Pub. Date: Sep. 24, 2026

(54) INFORMATION PROCESSING DEVICE, INFORMATION PROCESSING SYSTEM,INFORMATION PROCESSING METHOD, AND STORAGE MEDIUM

(71) Applicant: HONDA MOTOR CO., LTD., Tokyo (JP)

(72) Inventors: Masahiro Kimura, Wako-shi (JP); Tetsuya Gomi, Tokyo (JP); Yoko Umeyama, Tokyo (JP); Taiki Iwama, Tokyo (JP); Ryuji Iwashita, Wako-shi (JP); Seungho Choi, Wako-shi (JP); Kotaro Masuda, Wako-shi (JP); Yuji Yasui, Wako-shi (JP); Jing Zhao, Tokyo (JP); Adil Gupta, Tokyo (JP); Ryo Takebayashi, Tokyo (JP)

(21) Appl. No.: 19/550,091

(22) Filed: Feb. 25, 2026

(30) Foreign Application Priority Data
Mar. 24, 2025 (JP) 2025-048835

(51) Int. Cl. G06V 20/59; B60Q 9/00; G06T 7/73; G06V 20/54; G06V 20/58; G06V 40/16; G06V 40/18

(52) U.S. Cl. CPC G06V 20/597; B60Q 9/00; G06T 7/74; G06V 20/54; G06V 20/58; G06V 40/171; G06V 40/18; G06T 2207/30201; G06T 2207/30261

(57) ABSTRACT

An information processing device includes an acquisition unit configured to acquire a surrounding image of a vehicle and a face image of a driver of the vehicle, a risk detection unit configured to detect a risk object in the surrounding image, an overlooking determination unit configured to determine presence or absence of overlooking of the risk object by the driver on the basis of information relating to a position of the risk object and information relating to the face image, a generation unit configured to generate visual field map information that includes a first area including a center of the visual field of the driver and a second area positioned outside the first area, on the basis of information relating to the position of the risk object, the presence or absence of the overlooking, and a visual line detected from the face image.

### CROSS-REFERENCE TO RELATED APPLICATION

Priority is claimed on Japanese Patent Application No. 2025-048835, filed Mar. 24, 2025, the content of which is incorporated herein by reference.

### BACKGROUND OF THE INVENTION

### Field of the Invention

The present invention relates to an information processing device, an information processing system, an information processing method, and a storage medium.

### Description of Related Art

In recent years, efforts have been actively made to provide access to a sustainable transportation system with special attention to people in vulnerable situations such as aged people, people with disabilities, and children among traffic participants. To implement this, research and development for further improving the safety or convenience of traffic through development on means for transportation for aged people or people with disabilities has been focused on (for example, see Patent Documents 1 and 2 described below).

[Patent Document 1] Japanese Unexamined Patent Application, First Publication No. 2020-71528

[Patent Document 2] Japanese Unexamined Patent Application, First Publication No. 2017-16568

### SUMMARY OF THE INVENTION

When a driver is suffering from visual field narrowing (visual field loss), a driver's ability to avoid a risk object is reduced. However, the driver may be unaware of visual field narrowing. When the driver continues driving while being unaware of visual field narrowing and reduction in ability due to visual field narrowing, there is a possibility that the safety or convenience of traffic is impaired.

An aspect according to the present invention has been made in consideration of such a situation, and an object of the present invention is to provide an information processing device, an information processing system, an information processing method, and a storage medium capable of detecting visual field narrowing of a driver. The present invention, in turn, contributes to development of a sustainable transportation system.

To solve the above-described problem, the present invention employs the following aspects.

(1) An information processing device according to an aspect of the present invention includes an acquisition unit configured to acquire a surrounding image of a vehicle and a face image of a driver of the vehicle, a risk detection unit configured to detect a risk object in the surrounding image, an overlooking determination unit configured to determine presence or absence of overlooking of the risk object by the driver on the basis of information relating to a position of the risk object and information relating to the face image, a generation unit configured to generate visual field map information in which information relating to an occurrence frequency of the overlooking and a direction within a visual field of the driver are associated with each other and which includes a first area including a center of the visual field of the driver and a second area positioned outside the first area, on the basis of information relating to the position of the risk object, the presence or absence of the overlooking, and a visual line detected from the face image, and an abnormality determination unit configured to determine that an abnormality occurs in the driver when the overlooking occurs more than a predetermined reference value by a predetermined threshold or more in the second area of the visual field map information.

(2) In the aspect of (1) described above, the information processing device may further include a visual line detection unit configured to detect the visual line from the face image.

(3) In the aspect of (1) or (2) described above, the information processing device may further include a notification control unit configured to cause a notification unit to perform notification when determination is made that the abnormality occurs in the driver.

(4) In the aspect of (3) described above, the notification control unit may cause the notification unit to perform the notification at a timing other than during driving of the vehicle by the driver.

(5) In the aspect of any one of (1) to (4) described above, the information processing device may further include an alarm control unit configured to cause an alarm unit to give an alarm on the basis of information relating to the position of the risk object.

(6) An information processing system according to an aspect of the present invention includes the information processing device of the aspect of any one of (1) to (5) described above further including an notification control unit configured to cause a notification unit to perform a notification when determination is made that the abnormality occurs in the driver, a first terminal device that is used by the driver and is not the notification unit in which the notification is controlled by the notification control unit, and a second terminal device that is used by a user different from the driver and is the notification unit in which the notification is controlled by the notification control unit, in which the second terminal device causes the first terminal device to perform a notification on the basis of information input by an operation of the user.

(7) An information processing method according to an aspect of the present invention causes a computer to execute processing of acquiring a surrounding image of a vehicle and a face image of a driver of the vehicle, processing of detecting a risk object in the surrounding image, processing of determining presence or absence of overlooking of the risk object by the driver on the basis of information relating to a position of the risk object and information relating to the face image, processing of generating visual field map information in which information relating to an occurrence frequency of the overlooking and a direction within a visual field of the driver are associated with each other and which includes a first area including a center of the visual field of the driver and a second area positioned outside the first area, on the basis of information relating to the position of the risk object, the presence or absence of the overlooking, and a visual line detected from the face image, and processing of determining that an abnormality occurs in the driver when the overlooking occurs more than a predetermined reference value by a predetermined threshold or more in the second area of the visual field map information.

(8) A non-transitory computer-readable storage medium according to an aspect of the present invention stores a program causing a computer to execute processing of acquiring a surrounding image of a vehicle and a face image of a driver of the vehicle, processing of detecting a risk object in the surrounding image, processing of determining presence or absence of overlooking of the risk object by the driver on the basis of information relating to a position of the risk object and information relating to the face image, processing of generating visual field map information in which information relating to an occurrence frequency of the overlooking and a direction within a visual field of the driver are associated with each other and which includes a first area including a center of the visual field of the driver and a second area positioned outside the first area, on the basis of information relating to the position of the risk object, the presence or absence of the overlooking, and a visual line detected from the face image, and processing of determining that an abnormality occurs in the driver when the overlooking occurs more than a predetermined reference value by a predetermined threshold or more in the second area of the visual field map information.

According to the aspects of the present invention, it is possible to detect visual field narrowing of the driver.

### BRIEF DESCRIPTION OF THE DRAWINGS

FIG. 1 is a diagram showing an example of a configuration and a usage environment of a driving monitoring device including an information processing device according to a first embodiment.

FIG. 2 is a diagram showing an example of the driving monitoring device.

FIG. 3 is a diagram showing an example of an image acquired by the driving monitoring device.

FIG. 4 is a diagram illustrating overlooking alarm processing that is performed by the driving monitoring device.

FIG. 5 is a diagram showing an example of information that is detected by a detection unit.

FIG. 6 is a diagram showing an example of an alarm that is performed by an alarm unit.

FIG. 7 is a diagram illustrating abnormality notification processing that is performed by the driving monitoring device.

FIG. 8 is a diagram showing an example of determination history information.

FIG. 9 is a diagram showing an example of visual field map information.

FIG. 10 is a flowchart showing an example of a flow of processing that is executed by an abnormality determination unit.

FIG. 11 is a diagram showing an example of visual field map information.

FIG. 12 is a diagram illustrating abnormality notification processing in an information processing system according to a second embodiment.

### DETAILED DESCRIPTION OF THE INVENTION

Hereinafter, an embodiment of an information processing device, an information processing system, an information processing method, and a storage medium of the present invention will be described with reference to the drawings. In the following description, a front direction of a vehicle is referred to as a plus X direction, a rear direction of the vehicle is referred to as a minus X direction, a right direction that is a width direction of the vehicle with respect to the plus X direction is referred to as a plus Y direction, a left direction is referred to as a minus Y direction, and a height direction of the vehicle that is a direction perpendicular to the X direction and the Y direction is referred to as a plus Z direction.

### First Embodiment

### Overall Configuration

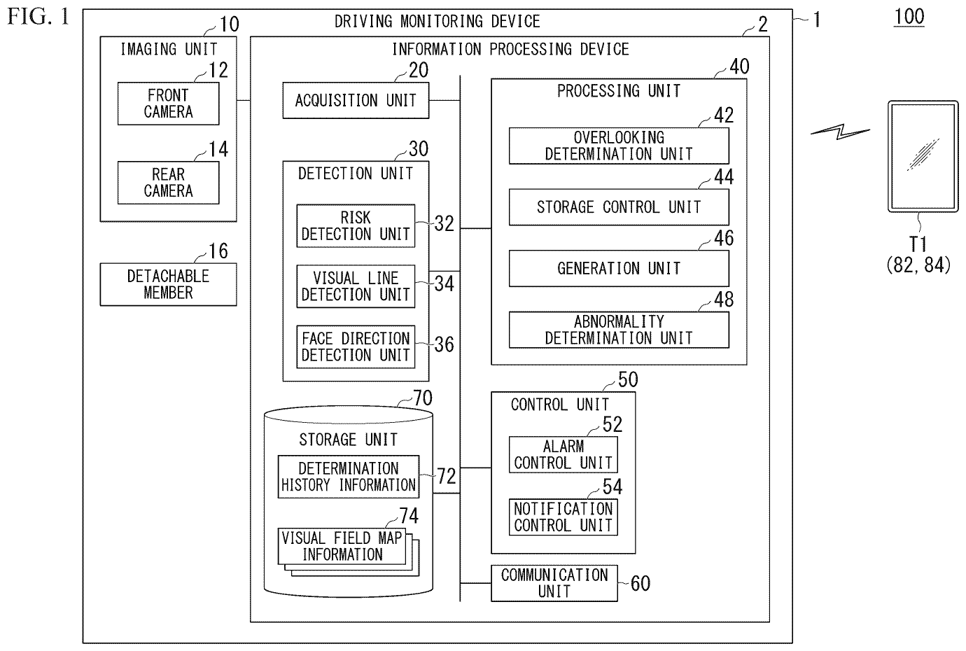

FIG. 1 is a diagram showing an example of a configuration and a usage environment of a driving monitoring device 1 including an information processing device 2 according to a first embodiment. The information processing device 2 is mounted in, for example, the driving monitoring device 1 that is retrofitted to a vehicle (hereinafter, referred to as a “vehicle M”) such as a drive recorder. That is, the driving monitoring device 1 (information processing device 2) is attachable and detachable to and from the vehicle M via a detachable member (hereinafter, referred to as a “detachable member 16”). The information processing device 2 is, for example, a device that is not connected to an in-vehicle network of the vehicle M. The in-vehicle network is an in-vehicle network using a communication standard such as a controller area network (CAN) to which an electronic control unit (ECU) regarding starting, braking, steering of the vehicle M, or vehicle control such as various sensors of the vehicle, operation members regarding driving, and operation buttons is connected. A network of the vehicle M for a human machine interface (HMI) may be excluded from the in-vehicle network.

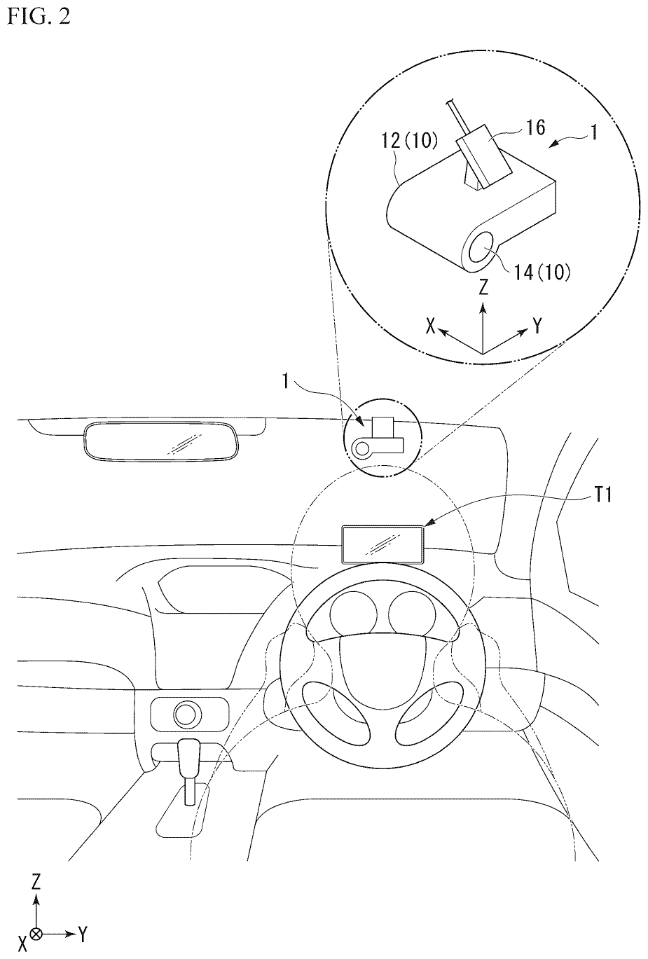

FIG. 2 is a diagram showing an example of the driving monitoring device 1. The driving monitoring device 1 is attached to, for example, a position in the vicinity of a front windshield of the vehicle M and near the front of a driver's seat. The driving monitoring device 1 stores an image (video) captured by the imaging unit 10 in, for example, a storage unit 70 (described below). The driving monitoring device 1 includes, for example, a display device such as a liquid crystal display (LCD), and may be configured to display an image (video) stored in the storage unit 70 on the display device.

The driving monitoring device 1 includes, for example, an imaging unit 10, the detachable member 16, and the information processing device 2. In the example shown in the drawing, the imaging unit 10 includes a front camera 12 and a rear camera 14.

Each of the front camera 12 and the rear camera 14 is, for example, a digital camera using a solid-state imaging element such as a charge coupled device (CCD) or a complementary metal oxide semiconductor (CMOS). The front camera 12 repeatedly (periodically) images the surroundings in front of the vehicle M from a position where the driving monitoring device 1 is attached. The rear camera 14 repeatedly (periodically) images the surroundings behind the vehicle M and the inside of a vehicle cabin of the vehicle M from the position where the driving monitoring device 1 is attached. An angle of view in a horizontal direction at which each of the front camera 12 and the rear camera 14 images is, for example, 180° or more. That is, the driving monitoring device 1 (imaging unit 10) images a range of 360° surrounding the vehicle M from the attached position. Each of the front camera 12 and the rear camera 14 may be, for example, a fisheye camera including a fisheye lens. Alternatively, each of the front camera 12 and the rear camera 14 may be a wide angle camera or the like. In the present embodiment, while a case where the front camera 12 and the rear camera 14 are used will be described, other cameras may be used instead of or in addition to the front camera 12 and the rear camera 14. That is, the imaging unit 10 may be configured such that an image (a surrounding image and a face image described below) for use in the present embodiment is imaged.

The detachable member 16 is, for example, a member for mounting the driving monitoring device 1 on the vehicle M. The detachable member 16 is any member, for example, a support member such as a sucker, a seal, or a bracket. The detachable member 16 may include a power supply cable (wire or the like) for supplying power to the driving monitoring device 1.

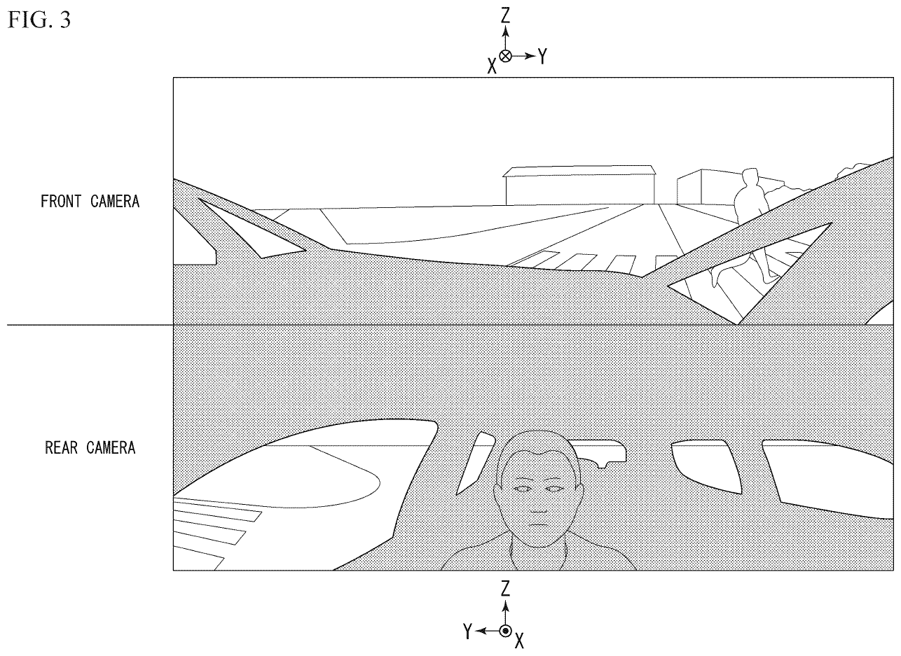

FIG. 3 is a diagram showing an example of an image acquired by the driving monitoring device 1. That is, FIG. 3 is a diagram showing an example of an image captured by the imaging unit 10. The front camera 12 images the front view of the vehicle M over a front windshield, a window on a driver's seat side, and a window on an assistant driver's seat side. The rear camera 14 images the inside (an occupant including a driver) of the vehicle cabin of the vehicle M, the rear view of the vehicle M over the window on the driver's seat side, the window on the assistant driver's seat, and a rear windshield, and the like.

In an image (hereinafter, referred to as a “front image”) captured by the front camera 12, as a subject, for example, the front view of the vehicle M seen through the front windshield such as another vehicle, a pedestrian, a bicycle, a fixed object, a road marking line and an object present on the right and left (front) of the vehicle M seen through the right and left windows are reflected.

In an image (hereinafter, referred to as a “rear image”) captured by the rear camera 14, the inside of the vehicle cabin of the vehicle M, the rear view of the vehicle M seen through the rear windshield, and an object present on the right and left (rear) of the vehicle M seen through the right and left windows are reflected. For this reason, in a rear view captured by the rear camera 14, as a subject, at least the driver of the vehicle M to which the driving monitoring device 1 is attached is reflected.

In the front image and the rear image, an image (hereinafter, referred to as a “surrounding image”) in which a surrounding situation of the vehicle M is imaged is included. In the rear image, an image (hereinafter, referred to as a “face image”) in which the face of the driver of the vehicle M is image is included. The driving monitoring device 1 may be attached on any place as long as the surrounding image and the face image can be captured by the imaging unit 10.

The information processing device 2 (see FIG. 1) outputs an alarm and notification via a first terminal device T1 on the basis of a result obtained by referring to the surrounding image and the face image output from the imaging unit 10. The driving monitoring device 1 and the first terminal device T1 may be collectively referred to as an “information processing system 100”.

The first terminal device T1 is, for example, a portable terminal device such as a smartphone or a tablet terminal that is used by the driver who drives the vehicle M to which the driving monitoring device 1 is attached. In the first terminal device T1, for example, an application for receiving an alarm and notification from the information processing device 2 is executed. The application displays an image based on information (for example, alarm information and notification information described below) transmitted from the information processing device 2 on the display device or causes a speaker to emit sound. The first terminal device T1 is also referred to as an alarm unit 82 and a notification unit 84. The first terminal device T1 is used in a state of being detachably attached to the vehicle M, for example. For example, a holder for the first terminal device T1 having a detachable member is provided in one or both of the first terminal device T1 and the vehicle M, and the first terminal device T1 is supported by the holder.

A navigation, a display unit, or a speaker of the vehicle M may be used instead of the first terminal device T1. That is, the navigation, the display unit, or the speaker of the vehicle M may output an alarm or notification on the basis of an instruction of the information processing device 2. That is, the navigation of the vehicle M or the display unit or the speaker of the vehicle M may be the alarm unit 82 or the notification unit 84. A display unit (the alarm unit 82 and the notification unit 84), a speaker (the alarm unit 82 and the notification unit 84), or the like may be provided in the driving monitoring device 1 instead of the first terminal device T1.

As shown in FIG. 1, the information processing device 2 includes, for example, an acquisition unit 20, a detection unit 30, a processing unit 40, a control unit 50, a communication unit 60, and a storage unit 70. The detection unit 30 includes a risk detection unit 32, a visual line detection unit 34, and a face direction detection unit 36. The processing unit 40 includes an overlooking determination unit 42, a storage control unit 44, a generation unit 46, and an abnormality determination unit 48. The control unit 50 includes an alarm control unit 52 and a notification control unit 54.

For the acquisition unit 20, the detection unit 30, the processing unit 40, and the control unit 50, the function of each component is implemented, for example, by providing a hardware processor such as a central processing unit (CPU) and a storage device (a storage device including a non-transitory storage medium) storing a program (software) and causing the processor to execute the program. Some or all of these components may be implemented by hardware (including a circuit unit; circuitry) such as a large scale integration (LSI), an application specific integrated circuit (ASIC), a field-programmable gate array (FPGA), or a graphics processing unit (GPU) or the function of each component may be implemented by cooperation of software and hardware. For some or all of these components, the function of each component may be implemented by a dedicated LSI.

The program (software) may be stored in advance in the storage unit 70 (a storage device including a non-transitory storage medium) such as a read only memory (ROM), a random access memory (RAM), or a flash memory in the information processing device 2 or may be stored in a removable storage medium (a non-transitory storage medium) such as a memory card and installed on the storage device when the storage medium is loaded into the driving monitoring device 1. The program (software) may be downloaded from another computer device through short-range communication or wide area communication by the application executed on the first terminal device T1, transmitted from the first terminal device T1, and installed on the storage device.

In the storage unit 70, for example, determination history information 72, visual field map information 74, a program (for example, the program described above), and various other kinds of information are stored. The storage unit 70 may be implemented by various storage devices described above, an electrically erasable programmable read only memory (EEPROM), or the like. The communication unit 60 is an interface for performing wireless communication or wired communication with an information processing device (external device) such as the first terminal device T1.

The driving monitoring device 1 (information processing device 2) performs at least overlooking alarm processing and abnormality notification processing. The overlooking alarm processing is processing of detecting overlooking of a risk object by the driver on the basis of the surrounding image and the face image and causing the alarm unit 82 to give an alarm. The abnormality notification processing is processing of detecting an abnormality (visual field narrowing) of the driver on the basis of the surrounding image and the face image and causing the notification unit 84 to perform notification.

The risk object is, for example, an object that the vehicle M should avoid. The risk object is, for example, an object with which the vehicle M interferes or is likely to interfere when moving in the present state. The object with which the vehicle M is likely to interfere is, for example, an object of which a degree of approach is equal to or greater than a predetermined degree after a predetermined time when a position, a moving direction, and a moving speed of an object and a position, a moving method, and a moving speed of the vehicle M are taken into consideration. The object may be a traffic participant such as a pedestrian, a bicycle, or a vehicle or may be an object such as an object placed on a road or a fallen object other than the traffic participant.

### Overlooking Alarm Processing

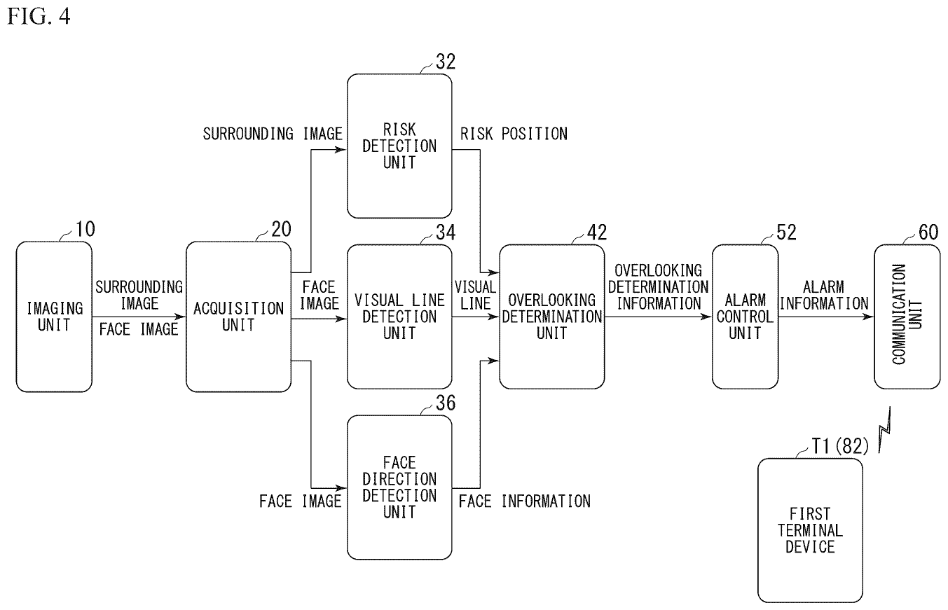

FIG. 4 is a diagram illustrating the overlooking alarm processing that is performed by the driving monitoring device 1 (information processing device 2).

The acquisition unit 20 acquires a front image and a rear image from the imaging unit 10. With this, the acquisition unit 20 acquires a surrounding image and a face image in association with each other. Because the imaging unit 10 repeatedly (periodically) captures the surrounding image and the face image, the acquisition unit 20 repeatedly (periodically) acquires the surrounding image and the face image. The acquisition unit 20 may acquire the surrounding image and the face image in association with a time (imaging time) at which these images are captured.

The risk detection unit 32 detects a risk object in the surrounding image. “Detecting a risk object” means, for example, detecting the presence of the risk object and a position (hereinafter, referred to as a risk position) of the risk object with respect to the vehicle M (driving monitoring device 1). For example, reference information (not shown) indicating a relationship between a risk position in the surrounding image and a relative position with respect to the vehicle M may be stored in advance in the storage unit 70. The risk detection unit 32 may detect the position of the risk object with respect to the vehicle M on the basis of the reference information.

The risk detection unit 32 detects a presence direction (approach direction) of a risk object with respect to the vehicle M by detecting the relative position of the risk object with respect to the vehicle M. “A presence direction of a risk object” means, for example, the presence direction of the risk object approaching the vehicle M (driving monitoring device 1) with respect to the vehicle M (driving monitoring device 1). Hereinafter, “the presence direction of the risk object” may be referred to as a “risk presence direction”.

The visual line detection unit 34 detects a visual line of the driver in the face image. Specifically, the visual line detection unit 34 detects the visual line of the driver by analyzing the face image using a predetermined image analysis method. “Detecting a visual line” means, for example, detecting a position of an eyeball of the driver and a direction of the visual line (a direction of the eyeball).

The face direction detection unit 36 detects at least a direction of a face of the driver in the face image. Specifically, the face direction detection unit 36 detects the direction of the face of the driver by analyzing the face image using a predetermined image analysis method. The face direction detection unit 36 may detect a position of the face of the driver in addition to the direction of the face of the driver. Hereinafter, information in which “the direction of the face” and “the position of the face” are combined may be referred to as “face information”. The face direction detection unit 36 detects the face information in the face image.

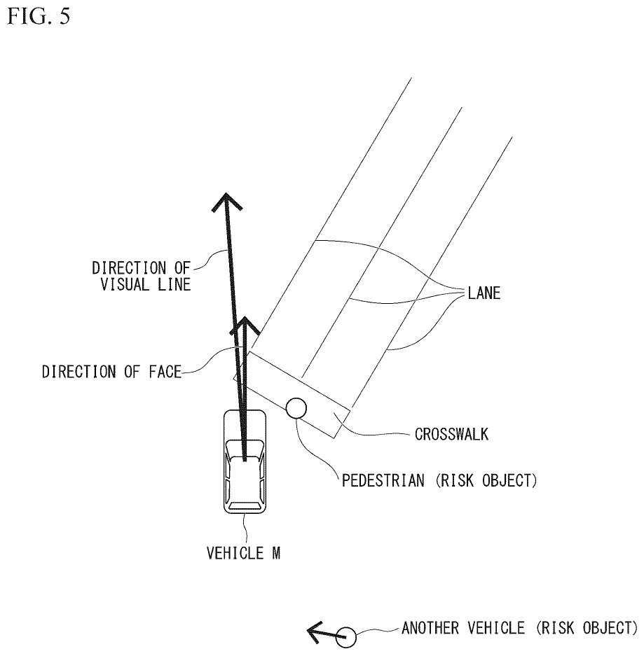

The detection unit 30 may be configured to detect a lane, a crosswalk, or the like in addition to the risk object, the visual line, and the face information described above. FIG. 5 is a diagram showing an example of information that is detected by the detection unit 30. In the example of FIG. 5, a pedestrian, another vehicle, lanes, and a crosstalk detected by the detection unit 30 are shown with the vehicle M, the direction of the visual line, and the direction of the face as a reference. The pedestrian and another vehicle are an example of a traffic participant (object) that is likely to be a risk object. For information that is detected by the detection unit 30, a traffic participant (object) that is detected by the detection unit 30 and is likely to be a risk object may be shown with the vehicle M, a direction of the vehicle M, and/or a proceeding direction of the vehicle M as a reference instead of the vehicle M, the direction of the visual line, and the direction of the face.

The overlooking determination unit 42 (see FIG. 4) determines the presence or absence of overlooking of a risk object by the driver on the basis of the risk position and/or the risk presence direction, the visual line, and the face information. Each of the “risk position” and the “risk presence direction” is an example of “information relating to a position of a risk object”. The visual line and the face information are an example of “information relating to a face image”.

For example, reference information (not shown) indicating a relationship between the direction of the eyeball (visual line) and/or the direction of the face of the driver in the face image and a relative direction with respect to the proceeding direction of the vehicle M may be stored in advance in the storage unit 70. The overlooking determination unit 42 may determine whether the direction of the visual line and/or the direction of the face match the risk presence direction with reference to the reference information. When the direction of the visual line and/or the direction of the face match the risk presence direction, the overlooking determination unit 42 may determine that the driver visually recognizes the risk object. “A case where the direction of the visual line and/or the direction of the face match the risk presence direction” may be, for example, a case where the risk position is present on a straight line along the direction of the visual line and/or the direction of the face. Alternatively, “a case where the direction of the visual line and/or the direction of the face match the risk presence direction” may be a case where the risk position is present in a conical area which has a center axis along the direction of the visual line and/or the direction of the face with the position of the visual point (eyeball) and/or the face as a vertex and in which the side spreads toward the front. When the direction of the visual line and/or the direction of the face do not match the position of the risk object, the overlooking determination unit 42 may determine that the driver does not visually recognize the risk object.

The overlooking determination unit 42 may determine that the overlooking of the risk object by the driver is present when a state in which the driver does not visually recognize the risk object is continued for a predetermined time or more. The overlooking determination unit 42 may determine that the overlooking of the risk object by the driver is absent when the driver visually recognizes the risk object or when a state in which the driver does not visually recognize the risk object is resolved before the predetermined time elapses. It should be noted that a determination method of overlooking by the overlooking determination unit 42 is not limited to the above-described method, and can be suitably changed.

The overlooking determination unit 42 generates overlooking determination information on the basis of the determination result. In the overlooking determination information, for example, the presence or absence of overlooking and the risk presence direction described above are included.

The alarm control unit 52 causes the first terminal device T1 (alarm unit 82) to output an alarm on the basis of the overlooking determination information. For example, the alarm control unit 52 transmits alarm information to the first terminal device T1 via the communication unit 60. In the alarm information, for example, information indicating the necessity for an alarm and the risk presence direction are included. The alarm control unit 52 generates alarm information including information indicating that “an alarm is necessary”, for example, when information indicating that “overlooking is present” is included in the overlooking determination information. The alarm control unit 52 generates alarm information including information indicating that “an alarm is not necessary”, for example, when information indicating that “an overlooking is absent” is included in the overlooking determination information. The first terminal device T1 outputs an alarm on the basis of the alarm information.

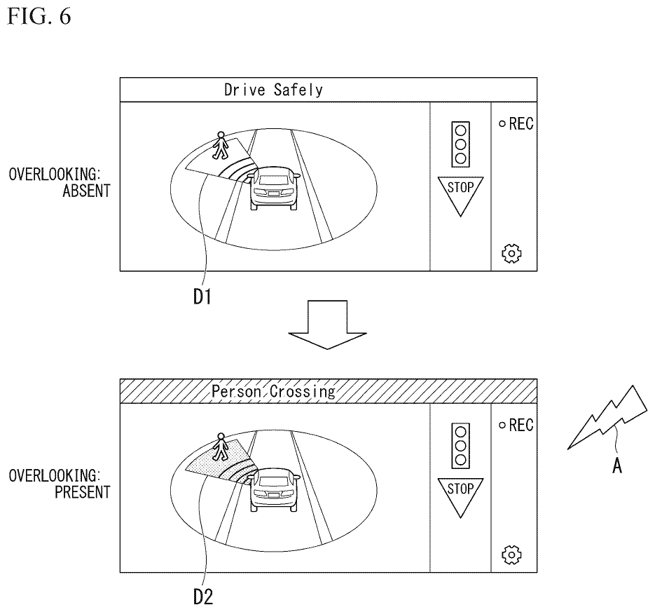

FIG. 6 is a diagram showing an example of an alarm that is performed by the first terminal device T1 (alarm unit 82). In the example of FIG. 6, the first terminal device T1 displays contents in which the risk presence direction (in the drawing, D1 and D2) can be recognized. Then, the first terminal device T1 performs an alarm by making a display aspect of the risk presence direction different between when the overlooking of the risk object is present (that is, when information indicating that “an alarm is necessary” is included in the alarm information) and when the overlooking of the risk object is absent (that is, when information indicating that “an alarm is not necessary” is included in the alarm information). Specifically, when the overlooking of the risk object is present, the risk presence direction is displayed in a more emphasized aspect compared to when the overlooking is absent. The emphasized aspect may be, for example, an aspect that allows the driver to more easily visually recognize the risk presence direction such as emphasis by color or emphasis by blinking or turning on an icon or the like. The first terminal device T1 may perform an alarm through emission of sound by a speaker or light emission of a light in addition to or instead of the above-described method (in the drawing, A). A specific method of an alarm can be suitably changed as long as the alarm can be recognized by the driver.

The alarm by the first terminal device T1 (alarm unit 82) may be performed, for example, at a timing at which the driver is driving the vehicle M (that is, in real time). Examples of “the timing at which the driver is driving the vehicle M” include a timing at which the vehicle M is traveling and a timing at which the vehicle M is temporarily stopped. For example, the transmission of the alarm information by the alarm control unit 52 may be performed at the above-described timing. Alternatively, the transmission of the alarm information by the alarm control unit 52 may be performed at any timing, and the first terminal device T1 (alarm unit 82) may control the timing of the alarm such that the alarm is performed at the above-described timing.

### Abnormality Notification Processing

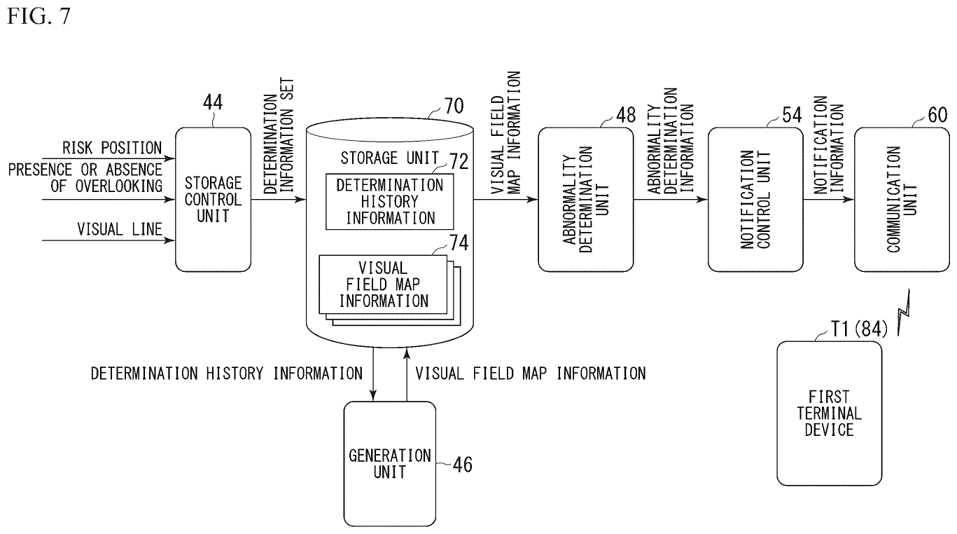

FIG. 7 is a diagram illustrating the abnormality notification processing that is performed by the driving monitoring device 1 (information processing device 2). The abnormality notification processing is also referred to as visual field narrowing notification processing.

The storage control unit 44 stores a determination time, the risk position, the presence or absence of the overlooking of the risk object, and the visual line described above in the storage unit 70 in association with one another. The determination time corresponds to, for example, the imaging time of the surrounding image and/or the face image used for the detection of the risk position, the determination of the presence or absence of the overlooking, and the detection of the visual line. The risk position is an example of “information relating to a position of a risk object”. The above-described processing (storage processing) by the storage control unit 44 is performed, for example, each time the overlooking determination information is generated by the overlooking determination unit 42. Hereinafter, information stored in the storage unit 70 in such a manner is referred to as the determination history information 72.

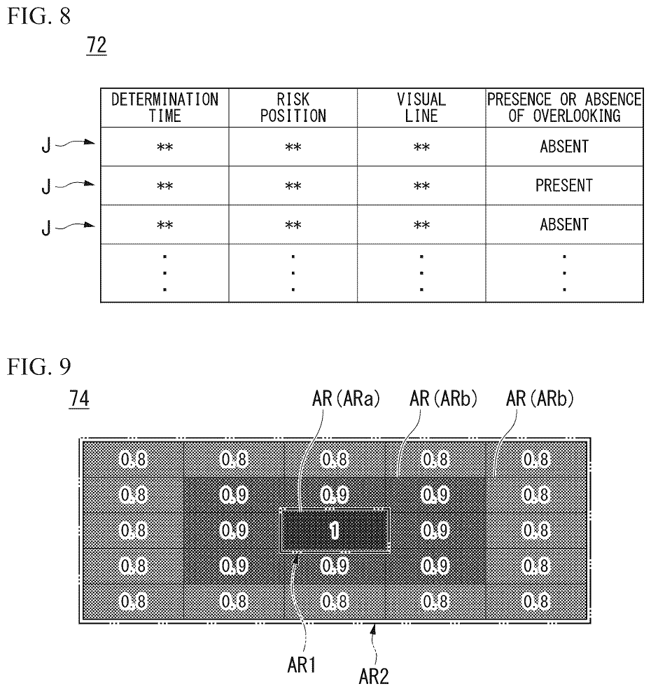

FIG. 8 is a diagram showing an example of the determination history information 72. The above-described storage processing is repeated by the storage control unit 44, so that a plurality of sets (hereinafter, referred to as a determination information set J) of information including the determination time, the risk position, the presence or absence of the overlooking, and the visual line are accumulated in the determination history information 72. That is, the storage control unit 44 generates the determination information set J each time the overlooking determination information is generated by the overlooking determination unit 42. Then, the storage control unit 44 updates the determination history information 72 by adding the generated determination information set J to the determination history information 72.

Returning to FIG. 7, the generation unit 46 generates the visual field map information 74 on the basis of the determination history information 72.

First, an example of the content of the visual field map information 74 will be described. FIG. 9 is a diagram showing an example of the visual field map information 74. The visual field map information 74 is information in which information relating to an occurrence frequency of the overlooking of the risk object by the driver and a direction within the visual field of the driver are associated with each other.

The visual field map information 74 includes, for example, a plurality of areas AR arranged in a two-dimensional shape (for example, in a two-dimensional lattice shape). Each area AR corresponds to the direction (hereinafter, referred to as an in-visual field direction) within the visual field of the driver. For example, the plurality of areas AR include a center area ARa corresponding to the center (front) of the visual field of the driver and a plurality of non-center areas ARb that are areas AR other than the center area ARa. In the visual field map information 74, a relative position of each non-center area ARb with respect to the center area ARa corresponds to a relative position of each in-visual field direction with respect to the center of the visual field in the visual field of the driver. The plurality of areas AR may be set such that, for example, an area in which all areas are combined includes the whole of a portion where the front windshield is reflected, of the visual field of the driver who performs driving while directing the visual line in the proceeding direction of the vehicle M. In other words, the area AR (non-center area ARb) positioned on the outermost circumference among the plurality of areas AR may correspond to an outer peripheral edge of the front windshield or a portion outside the outer peripheral edge of the visual field of the driver.

The visual field map information 74 includes a first area AR1 and a second area AR2. The first area AR1 is an area including the center (that is, the center area ARa) of the visual field of the driver. The second area AR2 is an annular area positioned outside the first area AR1. In the example shown in the drawing, the first area AR1 conforms to the center area ARa, and the second area AR2 conforms to an area in which all areas AR (non-center areas ARb) other than the center area ARa are combined. That is, the boundary between the first area AR1 and the second area AR2 conforms to a peripheral edge of the center area ARa. It should be noted that the boundary between the first area AR1 and the second area AR2 is not limited thereto, and can be suitably changed. For example, a boundary may be set such that a plurality of areas AR are included in the first area AR1. Information indicating the boundary between the first area AR1 and the second area AR2 (that is, information indicating whether each area AR belongs to the first area AR1 or the second area AR2) may be stored in advance in the storage unit 70.

A numerical value (0.8, 0.9, 1.0, and the like) stated in each area AR indicates a recognition rate of the driver with respect to a risk object that occurs in the area AR (in-visual field direction). The recognition rate is defined as, for example, “1—(overlooking rate)”. The overlooking rate is defined as a value obtained by dividing the number of times the risk object that occurs in the area AR has been overlooked by the number of times the risk object occurs in the area AR. The recognition rate is an example of “information relating to an occurrence frequency of overlooking of a risk object”. Hereinafter, “information relating to an occurrence frequency of overlooking of a risk object” may be referred to as an “overlooking frequency information”.

Here, the visual field map information 74 shown in FIG. 9 is information on a healthy person (that is, a person who is not suffering from a disease such as dementia or visual field loss). As shown in FIG. 9, in the visual field map information 74 of the healthy person, in general, the recognition rate is highest in the center area ARa, and the recognition rate is reduced symmetrically as a distance from the center area ARa increases. This is, in general, because vision or attention declines as a distance from the center of the visual field increases.

Next, an example of a generation method of the visual field map information 74 will be described. The generation unit 46 generates the visual field map information 74 as described above on the basis of the determination history information 72. For example, the generation unit 46 specifies an in-visual field direction in which the risk object occurs (in other words, an area AR in the visual field map information 74 to which the risk object corresponds), on the basis of the risk position and the visual line for each determination information set J included in the visual field map information 74.

For example, the generation unit 46 may calculate a risk vector and a visual line vector. The risk vector is a vector with the position of the eyeball as a start point and the risk position as an end point. The visual line vector is a vector that is directed in the direction of the visual line (eyeball) with the position of the eyeball as a start point and has predetermined magnitude. Then, the generation unit 46 may specify the in-visual field direction of the risk object as described above by obtaining an angle between the risk vector and the visual line vector.

The generation unit 46 may calculate the recognition rate (overlooking frequency information) in each area AR by performing predetermined statistical processing based on the specified in-visual field direction and the presence or absence of the overlooking included in the determination information set J. The calculation of the recognition rate is performed for all areas AR, whereby the generation of the visual field map information 74 is completed. For example, the generation unit 46 may perform the calculation of the recognition rate (the generation of the visual field map information 74) on the basis of the determination information set J belonging to a predetermined calculation period (for example, for the latest one year) in the determination history information 72.

The generation unit 46 stores the generated visual field map information 74 in the storage unit 70 in association with information indicating a calculation period. The generation of the visual field map information 74 by the generation unit 46 may be performed repeatedly in a predetermine cycle. In this case, the cycle in which the generation unit 46 generates the visual field map information 74 may be set on the basis of the calculation period. Alternatively, the generation of the visual field map information 74 may be performed according to an instruction of the driver or the like. The generation unit 46 repeats the generation of the visual field map information 74, whereby a plurality of pieces of visual field map information 74 having different calculation periods are stored (accumulated) in the storage unit 70.

The content and the generation method of the visual field map information 74 are not limited to the above-described example, and can be suitably changed. For example, the number of areas AR included in the visual field map information 74 or the wideness or narrowness of the range of the visual field to which each area AR corresponds can be suitably changed. An overlooking rate may be used as the overlooking frequency information or the number of times the driver has overlooked (or has not overlooked) the risk object may be used. The content of the visual field map information 74 can be suitably changed as long as the visual field map information 74 is information in which the overlooking frequency information and the direction within the visual field of the driver are associated with each other. The generation method of the visual field map information 74 can be suitably changed according to the content of the visual field map information 74.

Returning to FIG. 7, the abnormality determination unit 48 determines whether an abnormality (that is, visual field narrowing) occurs in the driver, on the basis of the visual field map information 74. The abnormality determination unit 48 generates abnormality determination information on the basis of a determination result. In the abnormality determination information, information indicating the presence or absence of the abnormality of the driver is included.

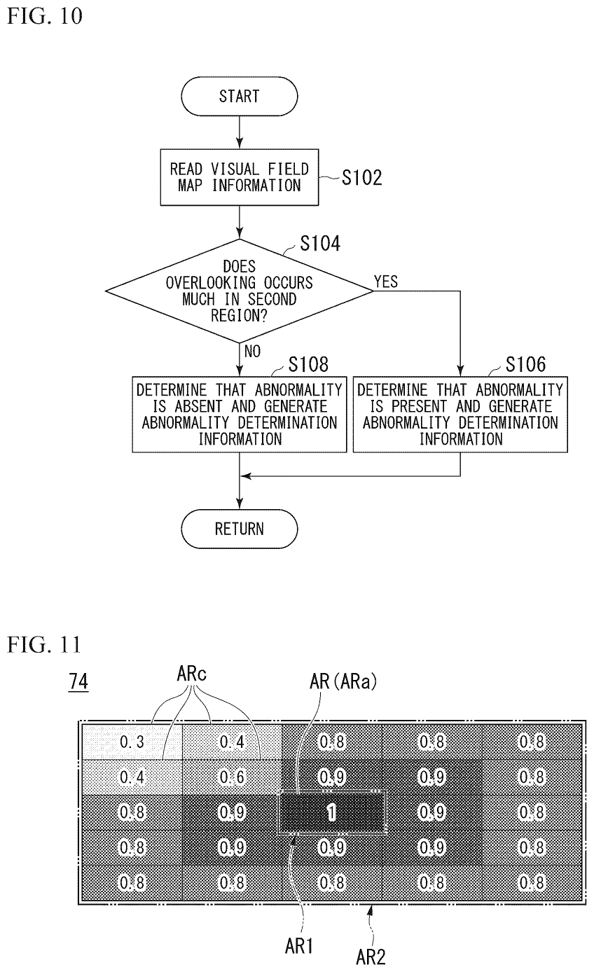

FIG. 10 is a flowchart illustrating an example of a flow of processing that is executed by the abnormality determination unit 48. The processing of the flowchart shown in FIG. 10 may be started, for example, repeatedly in a predetermined cycle, may be started each time the generation of the visual field map information 74 by the generation unit 46 is performed, or may be started according to an instruction of the driver or the like.

First, the abnormality determination unit 48 reads the visual field map information 74 from the storage unit 70 (Step S102). Specifically, the abnormality determination unit 48 reads, from the storage unit 70, the visual field map information 74 that is subject to determination of the presence or absence of an abnormality (visual field narrowing) in the driver. For example, the abnormality determination unit 48 may read the latest visual field map information 74 among the visual field map information 74 stored in the storage unit 70.

Next, the abnormality determination unit 48 determines whether overlooking occurs much in the second area AR2 of the read visual field map information 74 (Step S104). FIG. 11 is a diagram showing an example of the visual field map information 74 and is a diagram showing an example where overlooking occurs much in the second area AR2. In the example shown in FIG. 11, for example, the recognition rate is reduced in at least a partial area AR belonging to the second area AR2, compared to the visual field map information 74 of the healthy person as shown in FIG. 9. On the other hand, in other areas AR, a large reduction of the recognition rate is not viewed, compared to the visual field map information 74 of the healthy person as shown in FIG. 9, for example. Details of the determination processing (hereinafter, referred to as visual field narrowing determination processing) of Step S104 will be described below.

Returning to FIG. 10, when determination is made that overlooking occurs much in the second area AR2 (Step S104; YES), the abnormality determination unit 48 determines that an abnormality is present and generates abnormality determination information (Step S106). The abnormality determination unit 48 may include information indicating a specific area (hereinafter, referred to as a loss area) where overlooking occurs much, in the abnormality determination information to be generated. Thereafter, the abnormality determination unit 48 ends the processing of the flowchart shown in FIG. 10.

When determination is not made that overlooking occurs much in the second area AR2 (Step S104; NO), the abnormality determination unit 48 determines that an abnormality is absent and generates abnormality determination information (Step S108). That is, the abnormality determination unit 48 generates abnormality determination information including information indicating that an abnormality is absent in the driver. Thereafter, the abnormality determination unit 48 ends the processing of the flowchart shown in FIG. 10.

Returning to FIG. 7, the notification control unit 54 causes the first terminal device T1 (notification unit 84) to output a notification on the basis of the abnormality determination information. For example, the notification control unit 54 transmits notification information to the first terminal device T1 via the communication unit 60. For example, when information indicating that an abnormality is present in the driver is included in the abnormality determination information (that is, when the abnormality determination unit 48 determines that an abnormality occurs in the driver), the notification control unit 54 may transmit the notification information to the first terminal device T1. When information indicating a loss area is included in the abnormality determination information, information indicating the loss area may be included in the notification information. When information indicating that an abnormality is absent in the driver is included in the abnormality determination information (that is, when the abnormality determination unit 48 determines that an abnormality does not occur in the driver), the notification control unit 54 may not transmit the notification information to the first terminal device T1.

The first terminal device T1 (notification unit 84) outputs a notification on the basis of the notification information. The notification may be performed, for example, by displaying a character string, an image, or the like based on the notification information on the display device of the first terminal device T1 (notification unit 84). The first terminal device T1 (notification unit 84) may perform a notification indicating that visual field loss occurs or is likely to occur in the driver. When information indicating the loss area is included in the notification information, the first terminal device T1 (notification unit 84) may output contents (for example, a character string or an image) in which the driver or the like can recognize the loss area.

In the notification by the first terminal device T1 (notification unit 84), the content regarding a recommendation to receive a medical examination of a medical institution (for example, a family doctor of the driver) may be included. In this case, the first terminal device T1 (notification unit 84) may cause the driver to input information indicating whether the driver accepts to receive the medical examination of the medical institution. Specifically, a virtual button or the like indicating that the driver accepts to receive the medical examination may be displayed on the display device of the first terminal device T1 (notification unit 84). Such a button or the like functions as an acceptance information acquisition unit that acquires information (hereinafter, referred to as acceptance information) indicating the intention of the driver to accept to receive the medical examination of the medical institution. Then, when the driver operates the first terminal device T1 (notification unit 84), and the acceptance information acquisition unit acquires the acceptance information, the first terminal device T1 (notification unit 84) may cause a predetermined information processing terminal to perform a notification indicating that the driver accepts to receive the medical examination. The predetermined information processing terminal may be, for example, a terminal (for example, a second terminal device T2 described below) that is used in the medical institution. Specifically, the predetermined information processing terminal may be, for example, a terminal that is used by personnel (for example, a physician or a nurse) belonging to the medical institution.

It should be noted that an aspect of notification by the first terminal device T1 (notification unit 84) is not particularly limited as long as the driver can recognize the aspect, and can be suitably changed.

The notification by the first terminal device T1 (notification unit 84) may be performed, for example, at a timing other than the timing at which the driver is driving the vehicle M. Examples of “the timing other than the timing at which the driver is driving the vehicle M” include a timing at which the vehicle M is stopped, a timing after the drivers ends the driving of the vehicle M, and a timing at which the driver is separated from the vehicle M and stays at home. For example, the transmission of the notification information by the notification control unit 54 may be performed at the above-described timing. Alternatively, the transmission of the notification information by the notification control unit 54 may be performed at any timing, and the first terminal device T1 (notification unit 84) may control a timing of notification such that the notification is performed at the above-described timing.

### Details of Visual Field Narrowing Determination Processing

Hereinafter, details of the visual field narrowing determination processing will be described in connection with an example. It should be noted that the details of the visual field narrowing determination processing is not limited to the following example, and can be suitably changed.

The abnormality determination unit 48 reads, for example, the visual field map information 74 of the healthy person stored in advance in the storage unit 70 as reference map information. Alternatively, the abnormality determination unit 48 may read past visual field map information 74 generated by the generation unit 46 as reference map information. Thereafter, the abnormality determination unit 48 compares the overlooking frequency information (for example, the recognition rate) for each area AR included in the reference map information and the visual field map information 74 read (that is, that is subject to determination of the presence or absence of an abnormality in the driver) in the processing of Step S102 described above. In other words, processing of calculating a difference of the overlooking frequency information included in the visual field map information 74 from a reference value with the overlooking frequency information included in the reference map information as the reference value is performed for each area AR. Thereafter, the abnormality determination unit 48 specifies an area AR (hereinafter, referred to as a frequent overlooking occurrence area ARc) in which the difference from the reference value is a predetermined threshold or more. The predetermined threshold may be a value greater than 0 or may be 0.

Then, when the specified frequent overlooking occurrence area ARc is the area AR included in the second area AR2, the abnormality determination unit 48 may determine that “overlooking occurs much in the second area AR2”. In other words, when the frequent overlooking occurrence area ARc included in the second area AR2 is present, the abnormality determination unit 48 may determine that “overlooking occurs much in the second area AR2”. That is, the abnormality determination unit 48 may determine that “overlooking occurs much in the area AR” when overlooking occurs more than the above-described reference value by the above-described threshold or more in the second area AR2 of the visual field map information 74. The visual field map information 74 may specify an area where the frequent overlooking occurrence area ARc is distributed intensively, as the above-described loss area. When the specified frequent overlooking occurrence area ARc is the area AR included in the first area AR1 (when the frequent overlooking occurrence area ARc included in the first area AR1 is present), the abnormality determination unit 48 may not determine that “overlooking occurs much in the second area AR2”, may determine that an abnormality is absent, and may generate the abnormality determination information. As described above, in the present embodiment, according to whether the frequent overlooking occurrence area ARc belongs to the first area AR1 or the second area AR2, the content of the abnormality determination information to be generated is determined, and the contents of the notification information and the notification are determined. That is, the abnormality determination unit 48 compares the overlooking frequency information (for example, the recognition rate) with the reference value (for example, the recognition rate of the healthy person) for each area AR included in the visual field map information 74, and determines a normality and an abnormality of the driver on the basis of a result of the comparison.

According to the first embodiment described above, the information processing device 2 includes the acquisition unit 20 that acquires the surrounding image of the vehicle M and the face image of the driver of the vehicle M, the risk detection unit 32 that detects the risk object in the surrounding image, the overlooking determination unit 42 that determines the presence or absence of overlooking of the risk object by the driver on the basis of information relating to the position of the risk object and information relating to the face image, the generation unit 46 that generates the visual field map information 74 in which information relating to the occurrence frequency of the overlooking and the direction within the visual field of the driver are associated and which includes the first area AR1 including the center of the visual field of the driver and the second area AR2 positioned outside the first area AR1, on the basis of information relating to the position of the risk object, the presence or absence of the overlooking, and the visual line detected from the face image, and the abnormality determination unit 48 that determines that an abnormality occurs in the driver when the overlooking occurs more than the predetermined reference value by the predetermined threshold or more in the second area AR2 of the visual field map information 74. With this, it is possible to detect the visual field narrowing of the driver.

### Second Embodiment

Next, while a second embodiment will be described, a basic configuration is similar to the first embodiment. For this reason, similar configurations are represented by the same reference numbers, and description thereof will not be repeated. Only differences will be described.

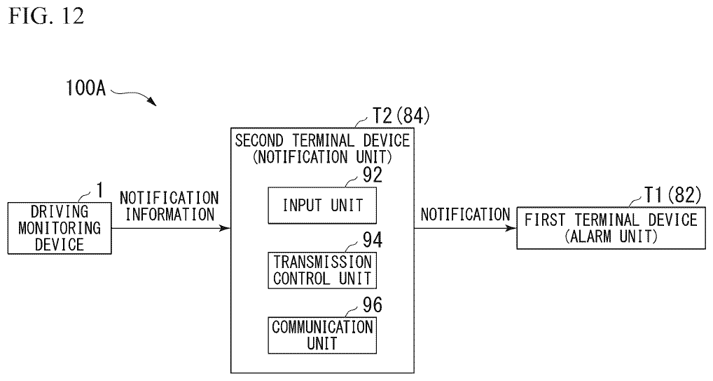

FIG. 12 is a diagram illustrating abnormality notification processing in an information processing system 100A according to the second embodiment. As shown in FIG. 12, the information processing system 100A according to the second embodiment includes a second terminal device T2 in addition to the driving monitoring device 1 and the first terminal device T1.

The second terminal device T2 is an information processing device that is used by a user (for example, a staff member of a hospital or an insurance company) different from the driver who uses the first terminal device T1. The second terminal device T2 may be, for example, a smartphone, a tablet terminal, or a personal computer.

In the second embodiment, the driving monitoring device 1 (notification control unit 54) transmits the notification information to the second terminal device T2, not to the first terminal device T1. That is, in the second embodiment, the notification unit 84 in which the notification is controlled by the notification control unit 54 is the second terminal device T2, not the first terminal device T1. In the second terminal device T2, for example, an application for receiving the notification by the information processing device 2 is executed. The application displays an image, a character string, or the like based on information (notification information or the like) transmitted from the information processing device 2 on the display device or causes a speaker to emit sound.

The second terminal device T2 causes the first terminal device T1 to perform a notification on the basis of information input by an operation of the user. The second terminal device T2 includes, for example, an input unit 92, a transmission control unit 94, and a communication unit 96.

For the input unit 92 and the transmission control unit 94, the function of each component is implemented, for example, by providing a hardware processor such as a CPU and a storage device (a storage device including a non-transitory storage medium) storing a program (software) and causing the processor to execute the program. Some or all of these components may be implemented by hardware (including a circuit unit) such as an LSI, an ASIC, an FPGA, or a GPU or the function of each component may be implemented by cooperation of software and hardware. For some or all of these components, the function of each component may be implemented by a dedicated LSI. The communication unit 96 is an interface for performing wireless communication or wired communication with an information processing device such as the first terminal device T1.

The input unit 92 receives an operation of the user and inputs the operation to the second terminal device T2. The input unit 92 is configured using existing input devices such as a keyboard, a pointing device (a mouse, a tablet, or the like), a button, and a touch panel. The input unit 92 may be an interface for connecting an input device to the second terminal device T2. In this case, the input unit 92 inputs an input signal generated according to an operation of the user on the input device to the second terminal device T2. The input unit 92 may have any configuration as long as a configuration is made in which an instruction based on an operation of the user can be input to the second terminal device T2.

For example, the user confirms the content of the notification from the second terminal device T2 caused by the driving monitoring device 1 (notification control unit 54), and examines the content that should be notified to the driver. The content to be notified to the driver is, for example, a recommendation of a medical examination of a medical institution for finding out the possibility of visual field loss (abnormality) or visual field loss. The user inputs information including the examined notification content to the second terminal device T2 by operating the input unit 92. The transmission control unit 94 transmits information input by the operation of the user to the first terminal device T1 via the communication unit 96. The first terminal device T1 performs a notification to the driver on the basis of the transmitted information.

The information processing system 100A may be configured to regulate the transmission of the notification information to the second terminal device T2 by the driving monitoring device 1 (notification control unit 54) according to an operation of the driver on the first terminal device T1 or the driving monitoring device 1. For example, regulation information indicating the presence or absence of regulation of the transmission of the notification information may be generated according to an operation of the driver on the first terminal device T1 or the driving monitoring device 1, and the generated regulation information may be stored in the storage unit 70. Then, the alarm control unit 52 may determine whether to transmit the notification information to the second terminal device T2, on the basis of the regulation information stored in the storage unit 70. According to such a configuration, determination regarding whether to inform the user who uses the second terminal device T2 of information relating to an abnormality of the driver is performed according to the intention of the driver. Accordingly, the privacy of the driver is easily protected.

According to the embodiment described above, the information processing system 100A includes the information processing device 2, the first terminal device T1 that is used by the driver and is not the notification unit 84 in which the notification is controlled by the notification control unit 54, and the second terminal device T2 that is used by the user different from the driver and is the notification unit 84 in which the notification is controlled by the notification control unit 54, and the second terminal device T2 causes the first terminal device T1 to perform the notification on the basis of information input by the operation of the user. With this, the notification content examined by the user who uses the second terminal device T2 can be provided to the driver who uses the first terminal device T1.

### Modification Examples

The technical scope of the present invention is not limited to the above-described embodiments, and various changes may be made without departing from the spirit of the present invention.

For example, the driving monitoring device 1 (information processing device 2) may perform another alarm processing (hereinafter, referred to as auxiliary alarm processing) in addition (or instead of) the above-described overlooking alarm processing. The auxiliary alarm processing may be, for example, collision alarm processing of detecting a possibility of collision of a risk object against the vehicle M on the basis of the position or relative speed of the risk object with respect to the vehicle M and causing the alarm unit 82 to give an alarm. In the collision alarm processing, the relative speed of the risk object with respect to the vehicle M may be calculated, for example, by analyzing a temporal change of the risk position detected by the risk detection unit 32 with the processing unit 40. “The relative speed of the risk object with respect to the vehicle M” is an example of “information relating to a position of a risk object”. When the possibility of collision of the risk object against the vehicle M is detected by the processing unit 40, the alarm control unit 52 may cause the alarm unit 82 to perform an alarm. Similarly to the overlooking alarm processing, the auxiliary alarm processing may be performed at the timing (that is, in real time) at which the driver is driving the vehicle M. In the configuration in which the driving monitoring device 1 (information processing device 2) performs the auxiliary alarm processing, the alarm by the alarm unit 82 based on the result of determination of overlooking by the overlooking determination unit 42 may not be performed. Also in this case, the determination of overlooking by the overlooking determination unit 42 is executed for the above-described abnormality notification processing.

Information relating to the result of the determination of overlooking by the overlooking determination unit 42, and the like are integrated in the storage unit 70 (for example, the determination history information 72), and contents (hereinafter, referred to as “review contents”) that are generated on the basis of the integrated information and allows the driver to review his/her driving in the past may be provided to the driver by the first terminal device T1 (alarm unit 82). The review contents may include, for example, information (character string, image, or the like) that allows the driver to confirm a risk object overlooked by the driver. The review contents may be generated by the driving monitoring device 1 (information processing device 2) or may be generated by the first terminal device T1 (alarm unit 82).

In the information processing system 100A according to the second embodiment, the driving monitoring device 1 (notification control unit 54) may transmit the notification information to both the first terminal device T1 and the second terminal device T2. In other words, both the first terminal device T1 and the second terminal device T2 may be the notification unit 84 in which a notification is controlled by the notification control unit 54.

In the first embodiment, the driving monitoring device 1 (information processing device 2) and the first terminal device T1 are configured as different devices, but may be configured as an integrated device. For example, all the functions of the imaging unit 10, the acquisition unit 20, the detection unit 30, the processing unit 40, the control unit 50, the storage unit 70, the alarm unit 82, and the notification unit 84 may be mounted in the driving monitoring device 1. Alternatively, all these functions may be mounted in the first terminal device T1 or the vehicle M. Also in the second embodiment, similarly, all the functions of the imaging unit 10, the acquisition unit 20, the detection unit 30, the processing unit 40, the control unit 50, the storage unit 70, and the alarm unit 82 may be mounted in the driving monitoring device 1 or all these functions may be mounted in the first terminal device T1. A camera other than the camera in the driving monitoring device 1 may be allowed to have a part or all of the functions of the imaging unit 10. For example, a driver monitor camera that images the driver may capture the face image.

The driving monitoring device 1 may be mounted using a plurality of information processing devices. For example, the functions of the information processing device 2 may be mounted in the first terminal device T1 or the vehicle M (for example, the ECU). Alternatively, the driving monitoring device 1 may be mounted using a device such as a cloud. For example, in the driving monitoring device 1, the detection unit 30, the processing unit 40, the control unit 50, and the storage unit 70 may be mounted in different information processing devices. For example, the storage unit 70 may be distributed and mounted in a plurality of information processing devices.

The embodiments and the modification examples described above can be expressed as follows.

An information processing device including
a storage medium that stores computer-readable instructions, and
a processor connected to the storage medium,
in which the processor executes the computer-readable instructions to
acquire a surrounding image of a vehicle and a face image of a driver of the vehicle,
detect a risk object in the surrounding image,
determine presence or absence of overlooking of the risk object by the driver on the basis of information relating to a position of the risk object and information relating to the face image,
generate visual field map information in which information relating to an occurrence frequency of the overlooking and a direction within a visual field of the driver are associated with each other and which includes a first area including a center of the visual field of the driver and a second area positioned outside the first area, on the basis of information relating to the position of the risk object, the presence or absence of the overlooking, and a visual line detected from the face image, and
determine that an abnormality occurs in the driver when the overlooking occurs more than a predetermined reference value by a predetermined threshold or more in the second area of the visual field map information.

The components in the embodiments described above can be appropriately replaced with well-known components without departing from the spirit of the present invention, and the embodiments and the modification examples described above may be appropriately combined.

What is claimed is:

1. An information processing device comprising:
an acquisition unit configured to acquire a surrounding image of a vehicle and a face image of a driver of the vehicle;
a risk detection unit configured to detect a risk object in the surrounding image;
an overlooking determination unit configured to determine presence or absence of overlooking of the risk object by the driver on the basis of information relating to a position of the risk object and information relating to the face image;
a generation unit configured to generate visual field map information in which information relating to an occurrence frequency of the overlooking and a direction within a visual field of the driver are associated with each other and which includes a first area including a center of the visual field of the driver and a second area positioned outside the first area, on the basis of information relating to the position of the risk object, the presence or absence of the overlooking, and a visual line detected from the face image; and
an abnormality determination unit configured to determine that an abnormality occurs in the driver when the overlooking occurs more than a predetermined reference value by a predetermined threshold or more in the second area of the visual field map information.

2. The information processing device according to claim 1, further comprising:
a visual line detection unit configured to detect the visual line from the face image.

3. The information processing device according to claim 1, further comprising:
a notification control unit configured to cause a notification unit to perform notification when determination is made that the abnormality occurs in the driver.

4. The information processing device according to claim 3,
wherein the notification control unit causes the notification unit to perform the notification at a timing other than during driving of the vehicle by the driver.

5. The information processing device according to claim 1, further comprising:
an alarm control unit configured to cause an alarm unit to give an alarm on the basis of information relating to the position of the risk object.

6. An information processing system comprising:
the information processing device according to claim 1 further including an notification control unit configured to cause a notification unit to perform notification when determination is made that the abnormality occurs in the driver;
a first terminal device that is used by the driver and is not the notification unit in which the notification is controlled by the notification control unit; and
a second terminal device that is used by a user different from the driver and is the notification unit in which the notification is controlled by the notification control unit,
wherein the second terminal device performs notification to the first terminal device on the basis of information input by an operation of the user.

7. An information processing method causing a computer to execute:
processing of acquiring a surrounding image of a vehicle and a face image of a driver of the vehicle;
processing of detecting a risk object in the surrounding image;
processing of determining presence or absence of overlooking of the risk object by the driver on the basis of information relating to a position of the risk object and information relating to the face image;
processing of generating visual field map information in which information relating to an occurrence frequency of the overlooking and a direction within a visual field of the driver are associated with each other and which includes a first area including a center of the visual field of the driver and a second area positioned outside the first area, on the basis of information relating to the position of the risk object, the presence or absence of the overlooking, and a visual line detected from the face image; and
processing of determining that an abnormality occurs in the driver when the overlooking occurs more than a predetermined reference value by a predetermined threshold or more in the second area of the visual field map information.

8. A non-transitory computer-readable storage medium storing a program causing a computer to execute:
processing of acquiring a surrounding image of a vehicle and a face image of a driver of the vehicle;
processing of detecting a risk object in the surrounding image;
processing of determining presence or absence of overlooking of the risk object by the driver on the basis of information relating to a position of the risk object and information relating to the face image;
processing of generating visual field map information in which information relating to an occurrence frequency of the overlooking and a direction within a visual field of the driver are associated with each other and which includes a first area including a center of the visual field of the driver and a second area positioned outside the first area, on the basis of information relating to the position of the risk object, the presence or absence of the overlooking, and a visual line detected from the face image; and
processing of determining that an abnormality occurs in the driver when the overlooking occurs more than a predetermined reference value by a predetermined threshold or more in the second area of the visual field map information.
